(19) United States
(12) Patent Application Publication
(10) Pub. No.: US 2025/0179704 A1
(43) Pub. Date: Jun. 5, 2025

(54) Methods and system for producing clothes and fabrics

(71) Applicant: Loophole Ltd., Rishpon (IL)

(72) Inventors: Aviad Maizels, Ramat Hasharon (IL); Doron Marco, Tel Aviv (IL)

(21) Appl. No.: 18/843,724

(22) PCT Filed: Feb. 6, 2023
(86) PCT No.: PCT/IB2023/051043

§ 371 Date: Sep. 4, 2024

Related U.S. Application Data
(60) Provisional application No. 63/317,984, filed on Mar. 9, 2022.

(51) Int. Cl. D04H 3/04; D04H 3/005; D04H 3/16

(52) U.S. Cl. CPC D04H 3/04; D04H 3/005; D04H 3/16; D10B 2501/00

(57) ABSTRACT

A system (11) includes: (i) an extrusion assembly (EA) (77, 78), which is configured to melt granules (20) of one or more substances and to output the molten granules onto a substrate (44), (ii) a motion assembly (13), which is configured to move the EA (77, 78) relative to the substrate (44) along a first axis, and to vibrate the substrate along a second axis, different from the first axis, while the EA (77, 78) outputs the molten granules so as to produce a line of a filament (22) on the substrate (44), and (iii) a processor (66), which is configured to control the EA (77, 78) and the motion assembly (13) to dispose the filament (22) on a predefined region of the substrate (44).

### CROSS-REFERENCE TO RELATED APPLICATIONS

This application claims the benefit of U.S. Provisional Patent Application 63/317,984, filed Mar. 9, 2022, whose disclosure is incorporated herein by reference.

### FIELD OF THE INVENTION

The present invention relates generally to production of fabrics and clothes, and particularly to methods and systems for producing clothes and fabrics using extrusion and machine learning techniques.

### BACKGROUND OF THE INVENTION

Various techniques for producing clothes and fabrics have been published.

For example, U.S. Patent Application Publication 2021/0025080 describes a bicomponent fiber that includes a first region formed of a condensation polymer and a second region formed from a polypropylene blend. The polypropylene blend includes (i) a propylene-based polymer having a density of 0.895 g/cm3 to 0.920 g/cm3 and a melt index, 12, as determined by ASTM D1238 at 230° C. and 2.16 kg of 0.5 to 150 g/10 minutes; (ii) a maleic anhydride-grafted polypropylene; and (iii) an inorganic Brønsted-Lowry acid having an acid strength pKa value at 25° C. of 1 to 6.5, wherein the polypropylene blend has a 0.03 to 0.3 weight percent of grafted maleic anhydride based on the total weight of the polypropylene blend. The first region is a core region of the bicomponent fiber, and the second region is a sheath region of the bicomponent fiber, where the sheath region surrounds the core region.

U.S. Patent Application Publication 2014/0000784 describes a method for producing a multilayer nonwoven web including a mono-component fiber layer and a multi-component fiber layer. The method may include the steps of spinning a plurality of mono-component fibers at a beam of mono-component fiber spinnerets and directing them toward a belt to form a mono-component batt layer; spinning a plurality of multicomponent fibers at a beam of multi-component fiber spinnerets and directing them toward the belt to form a multicomponent batt layer, wherein the layers are laid on the belt one super-adjacent the other to form a batt; and bonding the batt in a pattern of thermal bonds to form a multilayer nonwoven web.

U.S. Patent Application Publication 2021/0146606 describes a printing apparatus and manufacturing techniques for the manufacture and fabrication of pressure suits and space suits. The disclosure also relates to space suit components formed from additive polymer, and components including one or more layers of a mesh fabric with an applied layer of an additive polymer. One method includes providing an apparatus comprised of a six-degree of freedom motion manipulator with the motion manipulator attached to one or more printing extruder heads. Additive polymers may be extruded via the one or more printing extruder heads to form 3D printed space suit components.

U.S. Patent Application Publication 2019/0084196 describes articles for use in footwear and other applications, and associated systems and methods. Certain embodiments relate to methods for producing articles, such depositing a fiber onto a last to form non-woven materials. The fiber may be, for example, a pre-formed fiber, or a fiber that includes a reaction product of a composition extruded from one or more nozzles. In some embodiments, a method may comprise using one or more nozzles to deposit a fiber to form a non-woven material and to 3D-print one or more features onto the non-woven material. In some cases, articles may be formed that include fewer than five pieces of material. In some embodiments, an article may include a non-woven material that comprises thermoset fibers. In addition, some embodiments relate to lasts that may be suited to forming non-woven materials.

U.S. Pat. No. 10,696,034 describes methods, systems, and devices for extrusion-based three-dimensional printing. The methods, systems, and devices allow for the printing materials such as fabrics, clothing, and wearable and/or implantable devices. A number of different enhancements are provided that allow for this improved form of three-dimensional printing, including: (1) printing using a polymer (e.g., cellulose acetate) dissolved in a solvent (e.g., acetone); (2) selectively bonding portions of a deposited filament onto one or more surfaces and/or one or more previously deposited filaments; (3) using particular tool-paths to create a fabric or similar material by creating a woven pattern; and (4) printing across multiple layers even when previous layers are not complete.

U.S. Patent Application Publication 2011/0130063 describes a spinning apparatus capable of stably spinning fibers having a small fiber diameter with a high productivity, an apparatus comprising the same for manufacturing a nonwoven fabric, a process for manufacturing a nonwoven fabric using the nonwoven fabric manufacturing apparatus, and a non-woven fabric produced by the process. The spinning apparatus comprises one or more exits for extruding liquid, which are capable of extruding a spinning liquid, and one or more exits for ejecting gas, which extend linearly and are located upstream of each of the exits for extruding liquid and which are capable of ejecting a gas, wherein a shearing force by the gas and its accompanying airstream can be single-linearly exerted on the spinning liquid extruded. The apparatus for manufacturing a nonwoven fabric comprises a fibers collection means as well as the spinning apparatus. The process for manufacturing a nonwoven fabric is a process using the apparatus for manufacturing a nonwoven fabric. The nonwoven fabric is a nonwoven fabric produced by the process.

### SUMMARY OF THE INVENTION

An embodiment of the present invention that is described herein provides a system that includes a system including: (i) an extrusion assembly (EA), which is configured to melt granules of one or more substances and to output the molten granules onto a substrate, (ii) a motion assembly, which is configured to move the EA relative to the substrate along a first axis, and to vibrate the substrate along a second axis, different from the first axis, while the EA outputs the molten granules so as to produce a line of a filament on the substrate, and (iii) a processor, which is configured to control the EA and the motion assembly to dispose the filament on a predefined region of the substrate.

In some embodiments, the EA is configured to produce, along the line, one or more puddles of the molten granules. In other embodiments, the EA is configured to produce a section of the line by pulling a portion of the molten granules from the puddle and disposing the pulled portion on the substrate along the first axis. In yet other embodiments, the processor is configured to determine the predefined region by controlling: (i) a first movement profile for moving the EA along the first axis, and a second moving profile for vibrating the substrate in the second axis. In some embodiments, the processor is configured to control the motion assembly to move the EA in an opposite direction along the first axis, so as to dispose an additional filament on an additional predefined region of the substrate. In other embodiments, at least a portion of the predefined region overlaps at least a portion of the additional predefined region. In yet other embodiments, the processor is configured to control the motion assembly and the EA to produce a plurality of the filaments and the additional filaments, and to produce a first array of one or more bundles by coupling, in each of the bundles, between two or more of the filaments and the additional filaments.

In some embodiments, the processor is configured to control the motion assembly and the EA to produce at least one of the bundles by intertwining between one or more of the filaments and one or more of the additional filaments. In other embodiments, the processor is configured to control the motion assembly and the EA to produce at least one of the bundles by coupling, two or more of the filaments and the additional filaments, to a puddle of the molten granules. In yet other embodiments, the motion assembly is configured to rotate the substrate about a rotation axis, and the processor is configured to control: (i) the motion assembly to rotate the substrate at a predefined rotation angle, and (ii) the motion assembly and the EA to produce, on the substrate, a second array of one or more of the bundles.

In some embodiments, the processor is configured to control the motion assembly and the EA to produce a layer including at least two of the bundles of the first and second arrays intertwined with one another. In other embodiments, the processor is configured to control the motion assembly and the EA to produce the intertwined bundles in a crisscross configuration. In yet other embodiments, the processor is configured to control the motion assembly and the EA to produce the intertwined bundles at first and second orientations, respectively, and the first and second orientations define a given angle between the intertwined bundles. In some embodiments, the processor is configured to control the motion assembly and the EA to produce one or more reinforcement points (RPs) between one or more pairs of the intertwined bundles. In other embodiments, the processor is configured to control the motion assembly and the EA to produce at least one of the RPs by welding at least one of the pairs to one another. In yet other embodiments, the processor is configured to control the motion assembly and the EA to produce at least one of the RPs by soldering between the bundles of at least one of the pairs.

In some embodiments, the processor is configured to control the motion assembly and the EA to produce: (i) a first side of a fabric by producing one or more layers, and stacking a first plurality of the layers, and (ii) a second side of the fabric by producing one or more additional layers and stacking a second plurality of the additional layers. In other embodiments, the first side has at least a first edge and the second side has at least a second edge, and the processor is configured to control a coupling assembly to couple between the first and second edges for producing the fabric. In yet other embodiments, the processor is configured to control a robot to place a delamination layer between the first and second sides, so as to prevent undesired bonding between the first and second sides. In some embodiments, the first side is placed over the second side, such that the first and second edges are aligned, and the processor is configured to control a laser source to direct a laser beam to the aligned first and second edges, so as couple between the first and second edges. In other embodiments, the first side is placed over the second side, such that the first and second edges are aligned, and the processor is configured to control a suturing machine to stitch between the first and second edges. In yet other embodiments, before being melted, the granules have a size between 1 μm and 10 mm.

In some embodiments, at least one of the granules is made from a recycled fabric or a recycled item of clothing. In other embodiments, at least one of the granules includes a meltable polymer selected from a list of meltable polymers consisting of one or more of: (i) polyester, (ii) nylon, and (iii) polypropylene. In yet other embodiments, at least one of the granules includes the meltable polymer blended with cotton. In some embodiments, the EA includes a column and one or more screw extruders, which are disposed within the column and are configured to move the granules along the column. In other embodiments, the EA includes one or more heating units, which are configured to increase the temperature at a given section of the column for melting the granules. In yet other embodiments, the one or more heating units include: (i) a first heating unit, which is disposed at a first section of the column and is configured to heat the granules to a first temperature for increasing a pliability of granules, and (ii) a second heating unit, which is disposed at a second section of the column, different from the first section, and is configured to heat the granules to a second temperature, larger than the first temperature, for melting the granules.

In some embodiments, the EA includes one or more cooling ribs which are configured to dissipate the heat produced at the first and second sections from heating a third section of the column. In other embodiments, the EA includes a motor, which is configured to rotate at least one of the screw extruders for moving the granules along the column. In yet other embodiments, the EA includes one or more nozzles, and at least one of the nozzles is configured to produce the line by applying the molten granules onto the substrate.

In some embodiments, the nozzles include: (i) a first nozzle configured to produce a first line at a first region of the substrate, and (ii) a second nozzle configured to produce a second line at a second region of the substrate, different from the first region. In other embodiments, the EA includes an air curtain, which is configured to perform one or both of: (i) shaping the line of the filament produced on the substrate, and (ii) improve an attachment of the line of the filament to the substrate. In yet other embodiments, the EA includes a mechanism for increasing a flow rate of the molten granules, so as to produce a puddle along the line. In some embodiments, the mechanism includes a spring. In other embodiments, and including a machine learning (ML) engine, which is configured receive an input including one or more attributes of one or more physical properties of a fabric, and to output a mechanical structure of the fabric. In yet other embodiments, the mechanical structure includes one or more of: (i) one or more of the filaments, (ii) one or more puddles, (iii) one or more bundles produced by intertwining a plurality of the filaments, (iv) one or more layers including one or more arrays of first bundles and second bundles intertwined with one another.

In some embodiments, the ML engine is configured to output a recipe for producing the mechanical structure in the system. In other embodiments, the ML engine is implemented in a software, and the processor is configured to run the software. In yet other embodiments, the fabric includes a first fabric section having a first physical property and a second fabric section, different from the first fabric section, having a second physical property, different from the first physical property, and the ML engine is configured to output a first mechanical structure of the first fabric section, and a second mechanical structure of the second fabric section, which is different from the first mechanical structure. In some embodiments, the puddles are formed at random positions within the predefined region. In other embodiments, the puddles include: (i) a first puddle for bonding together a first number of the filaments, and (ii) a second puddle for bonding together a second number of the filaments, different from the first number.

There is additionally provided, in accordance with an embodiment of the present invention, a method, including melting, in an extrusion assembly (EA), granules of one or more substances and outputting the molten granules onto a substrate. The EA is moved the EA relative to the substrate along a first axis, and the substrate is vibrated along a second axis, different from the first axis, while the EA outputs the molten granules so as to produce a line of a filament on the substrate.

In some embodiments, the method includes producing, along the line, one or more puddles of the molten granules. In other embodiments, the method includes producing a section of the line by pulling a portion of the molten granules from the puddle and disposing the pulled portion on the substrate along the first axis.

The present invention will be more fully understood from the following detailed description of the embodiments thereof, taken together with the drawings in which:

### BRIEF DESCRIPTION OF THE DRAWINGS

FIG. 1 is a schematic, pictorial illustration of a system for producing fabrics and/or clothes, in accordance with an embodiment of the present invention;

FIG. 2A is a schematic front view of an extrusion assembly (EA) of the system of FIG. 1, in accordance with an embodiment of the present invention;

FIG. 2B is a schematic side view of the EA of the system of FIG. 1, in accordance with an embodiment of the present invention;

FIGS. 3-6 are schematic, pictorial illustrations of arrangement of bundles in layers of respective fabrics, in accordance with embodiments of the present invention;

FIG. 7 is a block diagram that schematically illustrates a machine-learning based system, which is configured to automatically determine a mechanical structure of a fabric based on physical properties of the fabric, in accordance with an embodiment of the present invention;

FIG. 8 is a schematic, pictorial illustration of an item of clothing produced by the system of FIG. 1, in accordance with an embodiment of the present invention;

FIG. 9 is a flow chart that schematically illustrates a method for producing an item of clothing, in accordance with an embodiment of the present invention; and

FIG. 10 is an image of the EA of the system of FIG. 1, in accordance with another embodiment of the present invention.

### DETAILED DESCRIPTION OF EMBODIMENTS

### Overview

Embodiments of the present invention that are described hereinbelow provide improved techniques for producing fabrics and clothes.

Typically, a piece of clothing (also referred to herein as an item of clothing), such as a shirt, is produced in three facilities: (i) a fiber factory for producing fibers, (ii) a fabric factory for processing the fibers into a fabric, and (iii) a clothing factory for cutting and shaping the fabrics, and subsequently, suturing or stitching the shaped fabrics to produce the clothing. The formation of a shirt in such facilities has several disadvantages, such as but not limited to high emission and spillage of waste (gas, liquid and solid), labor intensive, and having a long cycle time.

Moreover, such processes have limited flexibility, for example, (i) they are suitable for a low mix of products and high volume of units for each product, and (ii) every change or customization increases the cycle time and cost of producing an item of clothing. Furthermore, the recycling percentage of clothes and fabrics produced by such processes is negligible, and increases the amount of waste accumulated on Earth.

Therefore, fabric and clothing production techniques that improve, inter-alia, the flexibility, customization, and environment-friendliness, are highly required.

In some embodiments, a system for producing fabrics and clothes comprises an extrusion assembly (EA), a motion assembly and a processor. The EA is configured to receive granules of one or more substances, which are produced from recycled clothes or from any other source. The EA is configured to move the granules along a column, melt the granules and output the molten granules onto a movable substrate.

In some embodiments, the motion assembly is configured to move the EA relative to the substrate along a first axis (e.g., along the Y-axis of an XYZ coordinate system), and to vibrate the substrate in a second axis, different from the first axis. For example, the vibration may be carried out along the X-axis of the XYZ coordinate system, or in a direction that is a combination of the X and Y axes.

In such embodiments, the combined movement of the EA and the substrate in two different axes produces a line of a filament by the EA that applies the molten granules to the substrate. The line may have an irregular zigzag shape so as to intertwine a plurality of the filaments into a bundle. Note that the motion assembly is configured to vibrate the substrate using any suitable frequency or a suitable combination of frequencies. For example, the processor is configured to control the motion assembly to vibrate the substrate in a random motion profile in which the frequency or combination of frequencies alters over time.

In some embodiments, the EA is configured to produce, along the line, one or more puddles of the molten granules. The position of the puddles along the line may be random along the line, or alternatively, at predefined positions. Moreover, the EA is configured to produce a section of the line by pulling a portion of the molten granules from the puddle and disposing the pulled portion on the substrate along the first axis (e.g., along the Y-axis).

In some embodiments, the processor is configured to control the EA and the motion assembly to dispose the filament and the one or more puddles on a predefined region of the substrate. After producing the line of the filament, the processor is configured to control the motion assembly to reverse the movement direction of the EA along the Y-axis, and to continue the vibration of the substrate (as described above), so as to produce: (i) an additional line of an additional filament, and (ii) additional one or more puddles, as described above.

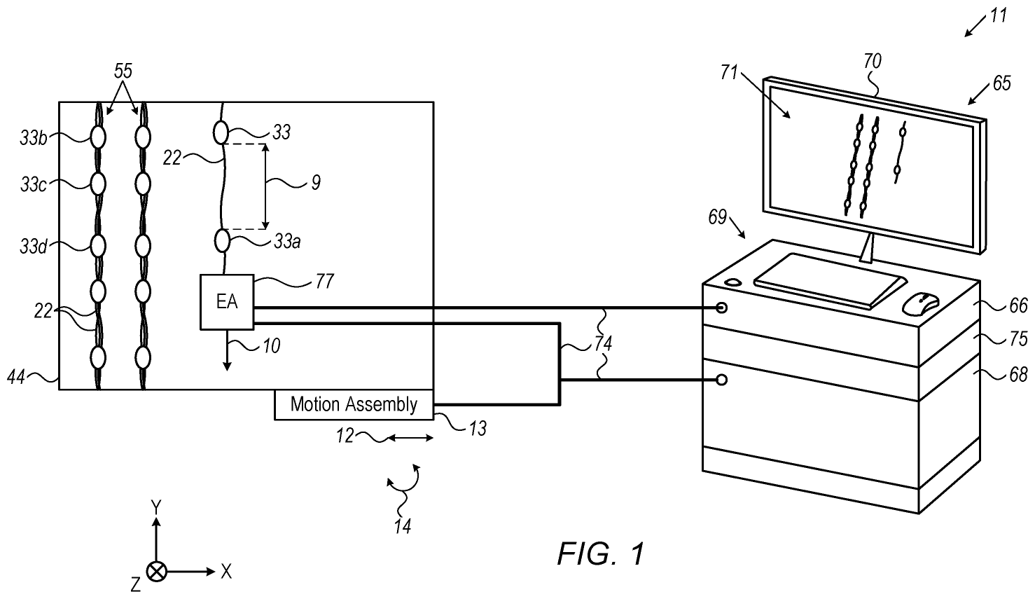

In some embodiments, the processor is configured to control the motion assembly to repeat the production of the filaments between about 30 times and 100 times, so as to produce a bundle of the filaments. Note that the filaments are bundled tightly together by: (i) using the puddles as bonding hubs of two or more filaments of the bundle, and (ii) by intertwining the filaments of the bundle, which is obtained by vibrating the substrate along the X-axis. In some embodiments, the processor is configured to control the EA and the motion assembly to produce the puddles at random positions within the region. Moreover, at least one of the puddles, and typically all the puddles, are positioned to bond together a random number of filaments. For example, a first puddle may bond together about 10 filaments, a second puddle may bond together about 50 filaments, and a third puddle may bond together about 70 filaments. The filament and bundle formation are described in detail in FIG. 1 below.

In other embodiments, the size, and the position of the puddle, relative to the filaments formed on the surface of the substrate, are indicative of the number of filaments bonded together by the puddle.

In some embodiments, the motion assembly is further configured to rotate the substrate about a rotation axis for producing a layer of the fabric or the item of clothing. The layer may be produced using a crisscross of two or more arrays of bundles. In such embodiments, the processor is configured to control the motion assembly to: (i) pause the movement of the EA and the vibration of the substrate, (ii) rotate the substrate, e.g., at an angle of about 90 degrees (or at any other suitable angle), and (iii) resume the substrate vibration and the movement of the EA along the first axis while outputting the molten granules onto the substrate.

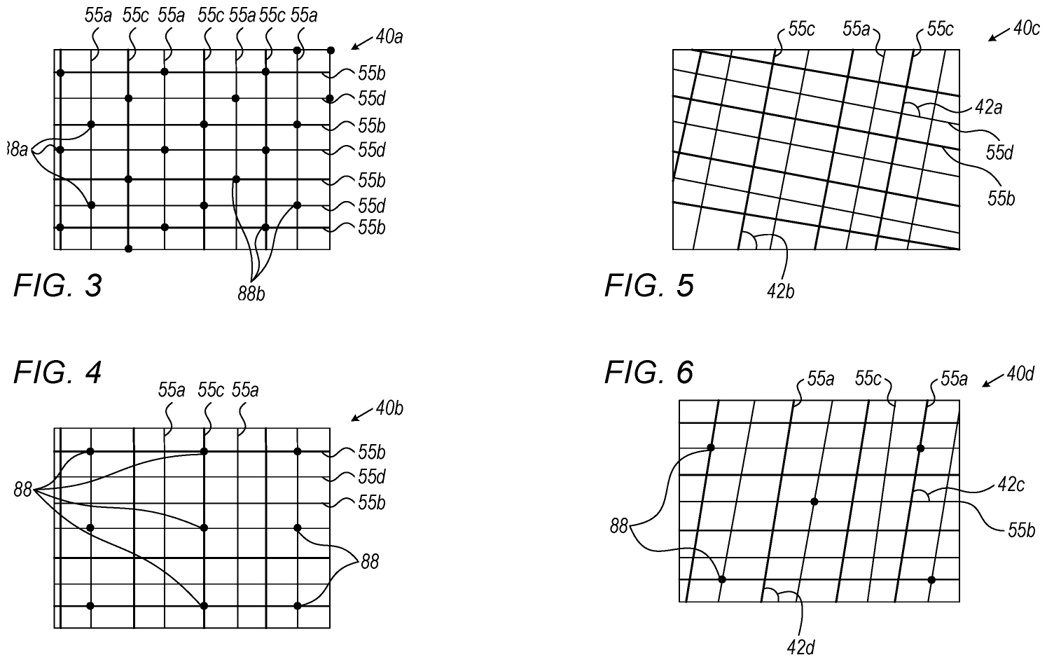

Additionally, or alternatively, the processor is configured to control the motion assembly to perform the rotating at any angle other than 90 degrees. Embodiments related to the crisscross and layer formation are described in detail in FIGS. 3, 4, 5 and 6 below.

In some embodiments, the processor is configured to determine the number of layers for each item of clothing and the structure of each layer.

In some embodiments, the mechanical structure of each layer (e.g., the number of bundles, the number of filaments and/or puddles per bundle, and the crisscross angle between the arrays of bundles arranged in a mesh) may determine physical properties of the respective layer.

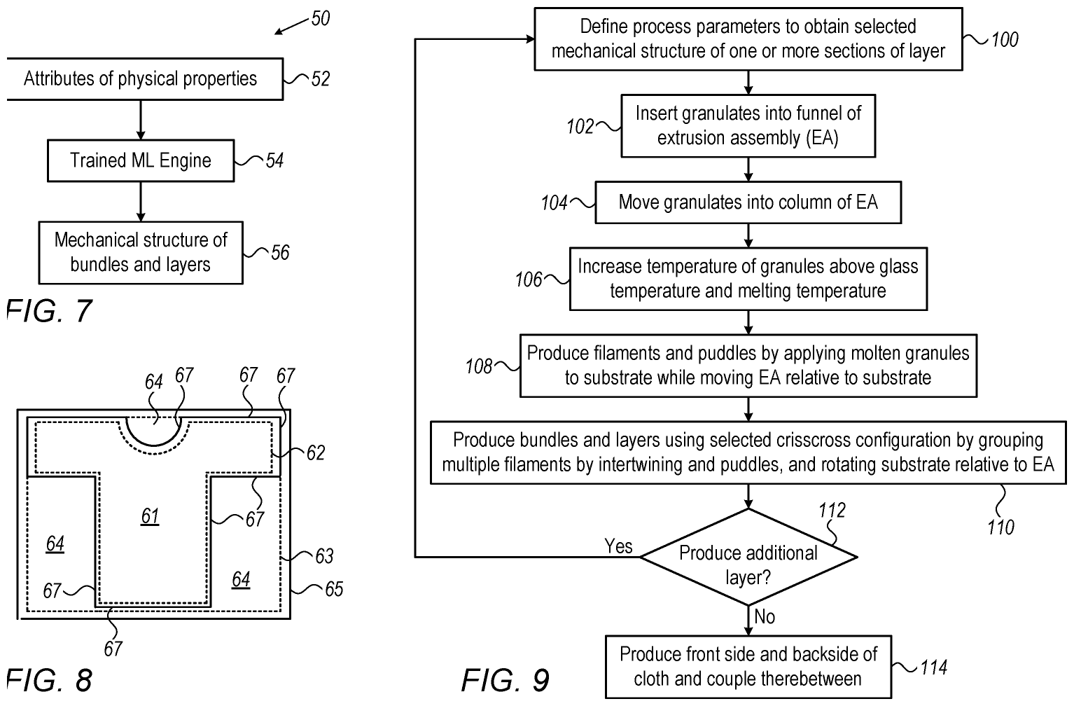

In some embodiments, the processor is configured to implement various techniques, such as machine learning, for determining the mechanical structure based on the desired physical properties of the layer and clothing. Note that each item of clothing is produced using a software-based recipe that defines the physical properties of the clothing, and therefore, improve the versatility and flexibility of the system to switch between the production of first and second items by extracting the respective recipe from the memory of the system. Embodiments related to such techniques are described in detail in FIG. 7 below.

In some embodiments, the processor is configured to control the system to: (i) produce the front side and the backside of the clothing, (ii) apply, between the front side and the backside, a buffer sheet, which is configured to prevent undesired bonding between the front and back sides, (iii) couple between the edges of the front and back sides, e.g., by stitching or suturing, and (iv) remove the buffer sheet, so as to conclude the production of the clothing. The process of producing the clothing by stitching the front and back sides is described in detail in FIG. 8 below.

The disclosed techniques improve the flexibility, cost effectiveness, customization, and environmental friendliness of processes for producing fabrics and clothes.

### System Description

FIG. 1 is a schematic, pictorial illustration of a system 11 for producing fabrics and/or clothes, in accordance with an embodiment of the present invention.

In some embodiments, system 11 comprises an extrusion assembly (EA) 77, a motion assembly 13 and an operating console 65 having a processor 66, a memory 75, input devices 69 (such as but not limited to mouse and keyboards) and a display 70 for displaying (i) an image 71 of the fabric and/or item of clothing processed in system 11, and/or (ii) any other suitable information related to system 11 and the production process of the fabrics and/or clothes.

Typically, processor 66 of console 65 comprises a general-purpose processor, which is programmed in software to carry out the functions described herein. The software may be downloaded to processor 66 in electronic form, over a network, for example, or it may, alternatively or additionally, be provided and/or stored on non-transitory tangible media, such as magnetic, optical, or electronic memory (e.g., memory 75).

In some embodiments, console 65 comprises a driver 68, which is configured to drive several motors of EA 77 and motion assembly 13 that are described hereinafter. System 11 comprises cables 74, which are configured to exchange signals between console 65 and (i) EA 77, and (ii) motion assembly 13.

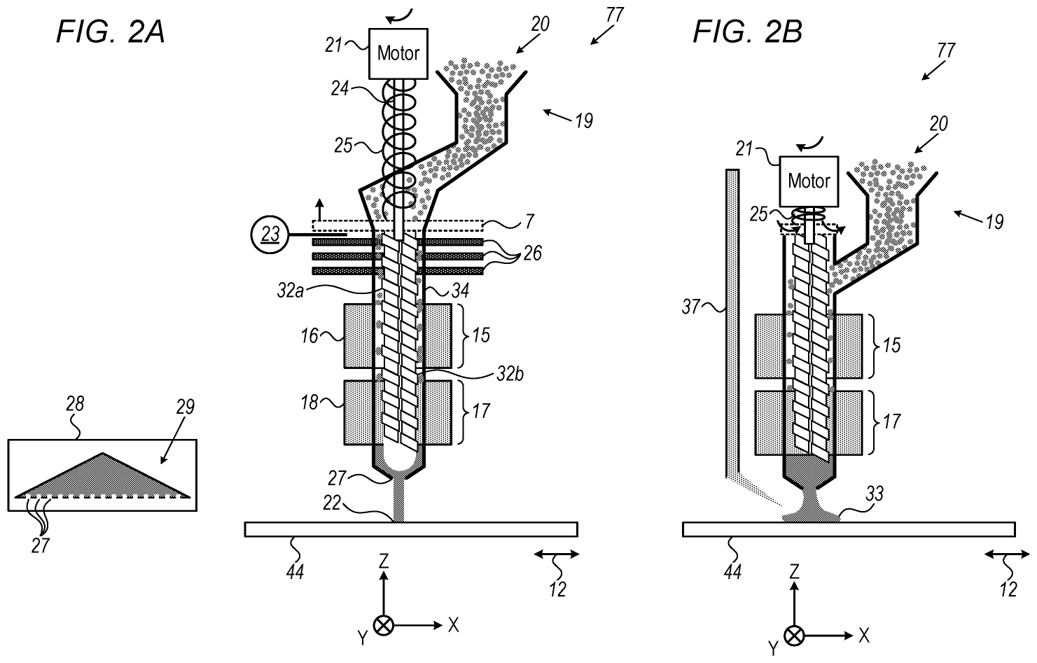

In some embodiments, EA 77, whose structure, and operation is described in detail in FIGS. 2A and 2B below, is configured to receive granules of one or more substances, which are produced from recycled clothes or from any other source. In the example of FIG. 1, EA 77 is configured to melt the granules (in a process described in FIGS. 2A and 2B below) and to output the molten granules onto the surface of a movable substrate 44.

In some embodiments, substrate 44 is made from a suitable metal (e.g., steel, stainless steel, or aluminum), and a magnetic film (not shown) is placed on substrate 44. After producing the fabric or item of clothing, the magnetic film is removed from substrate 44, and subsequently, the finished fabric or item of clothing is removed from the magnetic film.

In other embodiments, substrate 44 is made from any suitable material and is coated by a film of polytetrafluoroethylene (PTFE), also denoted Teflon, so that filaments 22 are attached to the surface of substrate 44, but the finished fabric may be removed from substrate 44.

In some embodiments, motion assembly 13, which may be implemented using any suitable type of a translation and rotation stage) is configured to move EA 77 and to move and/or vibrate substrate 44 at least in an XY plane of an XYZ coordinate system. In the example of FIG. 1, motion assembly 13 is configured to move EA 77 relative to substrate 44 along a Y-axis of an XYZ coordinate system. Motion assembly 13 is configured to vibrate substrate 44 in directions 12 (shown by a double headed arrow), which have at least a component parallel to an X-axis of the XYZ coordinate system, or in a direction that is a combination of the X and Y axes.

In some embodiments, the combined movement of EA 77 and substrate 44 in two different axes produces a line of a filament 22 by EA 77. The line is produced by melting the granules (completely or partially) within EA 77 in order to extrude and apply the molten granules to substrate 44.

In some embodiments, motion assembly 13 is configured to vibrate substrate 44 using any suitable frequency or a suitable combination of frequencies defined by processor 66 and carried out using waveform signals produced by driver 68.

In some embodiments, EA 77 is configured to produce, along the line of filament 22, one or more puddles 33 of the molten granules. Embodiments related to a technique for producing puddles 33 is described in FIGS. 2A and 2B below.

In some embodiments, EA 77 is configured to produce a section 9 of the line of filament 22 by pulling a portion of the molten granules from puddle 33 and disposing the pulled portion on the substrate along the Y-axis (or along a curved line of section 9 shown in the example of FIG. 1). More specifically, EA 77 is configured to pull a portion of the molten granules from puddle 33 while being moved (by motion assembly 13) toward the intended position of puddle 33a. Subsequently, EA 77 is configured to produce puddle 33a, and then continue to be moved by motion assembly 13 in a direction 10, which is typically parallel with Y-axis, as shown in the example FIG. 1. While being moved from puddle 33a in direction 10, EA 77 is configured to pull a portion of the molten granules from puddle 33a for producing the next line of filament 22.

In some embodiments, processor 66 is configured to control EA 77 and motion assembly 13 to dispose filament 22 and the one or more puddles (e.g., puddles 33 and 33a) on a predefined region of the substrate. In the context of the present disclosure and in the claims, the term “region” refers to the curved line (e.g., of section 9) which is disposed along an area rather than one axis, due to the combination of the EA 77 movement in direction 10 (e.g., along the Y-axis) and the vibration of substrate 44 in directions 12, as described above. In the context of the present disclosure and in the claims, (i) the movement of EA 77 in direction 10, and (ii) the vibration of substrate 44 in directions 12, are carried out using first and second movement profiles, respectively, which may be defined using one or more motion algorithms executed by processor 66 or by any other suitable processing device, which is configured to receive the algorithms implemented in a suitable software, and to apply the algorithms to motion assembly 13.

In some embodiments, after producing the line of filament 22, processor 66 is configured to control motion assembly 13 to reverse the movement direction of EA 77, e.g., opposite to direction 10 and along the Y-axis. At the same time, processor 66 is configured to control motion assembly 13 to continue the vibration of substrate 44, so as to produce: (i) an additional line of an additional filament 22, and (ii) additional one or more puddles 33, as described above. In the example of FIG. 1, puddles 33b and 33d are produced while EA 77 is moved in direction 10, and puddle 33c is produced while EA 77 is moved in the direction opposite to direction 10.

In some embodiments, processor 66 is configured to control motion assembly 13 to repeat the production of filaments 22 (using the techniques described above) between about 30 times and 100 times (or using any other suitable number of repetitions), so as to produce a bundle 55 made from a plurality of filaments 22. In the context of the present disclosure and in the claims, the term bundle also refers to a fiber made from a single filament 22 or from two more filaments 22 intertwined together using any suitable technique of the present disclosure.

In some embodiments, filaments 22 are bundled tightly together by: (i) using puddles 33 as bonding hubs or anchors of two or more filaments 22 of the bundle, and (ii) intertwining filaments 22 of the bundle, which is obtained by vibrating substrate 44 in directions 12 (e.g., along the X-axis) while moving EA 77 back and forth along the Y-axis.

In some embodiments, motion assembly 13 is further configured to rotate substrate 44 clockwise and counterclockwise in direction 14 (shown by a double headed arrow). The rotation of substrate 44 may be carried out about a rotation axis (e.g., parallel to the Z-axis of the XYZ coordinate system) for producing a layer of the fabric or item of clothing. Embodiments related to combinations of the layer formation are described in detail in FIGS. 3, 4, 5 and 6 below.

In the context of the present disclosure and in the claims, the terms “about” or “approximately” for any numerical values or ranges indicate a suitable dimensional tolerance that allows the part or collection of components to function for its intended purpose as described herein.

This particular configuration of system 11 and the process of producing the filaments and bundles, are simplified, and are shown by way of example, in order to illustrate certain problems that are addressed by embodiments of the present invention and to demonstrate the application of these embodiments in enhancing the performance of such a system. Embodiments of the present invention, however, are by no means limited to this specific sort of example system, and the principles described herein may similarly be applied to other sorts of systems.

FIG. 2A is a schematic front view of EA 77 of FIG. 1 above, in accordance with an embodiment of the present invention, and FIG. 2B is a schematic side view of EA 77 of FIG. 1 above, in accordance with an embodiment of the present invention.

Reference is now made to FIG. 2A.

In some embodiments, EA 77 comprises a funnel-shaped feeder 19, which is configured to receive and lead granules 20 into a column 34 of EA 77.

In some embodiments, granules 20 may be produced from recycled fabrics and clothes or from any other source. Granules 20 may comprise a meltable polymer, such as a thermoplastic, or a thermo-soft plastic, which is a plastic polymer material that becomes pliable or moldable or completely molten at a certain elevated temperature, and subsequently, being solidifies upon cooling. For example, granules 20 may comprise (i) polyester, (ii) nylon, (iii) polypropylene, and (iv) any suitable blend thereof, which is blended with cotton, so that when being melted, the molten granules comprise a mix and/or compound of the thermo-soft plastic and the cotton.

In some embodiments, processor 66 is configured to define, for each fabric or item of clothing, the substances and mixture thereof. For example, a first fabric may comprise about 90% cotton and about 10% thermo-soft plastic and other additives (e.g., for coloring the fabric), and a second fabric may comprise about 60% cotton and about 40% thermo-soft plastic and the other additives.

The size of the thermo-soft plastic granules 20 may range between about 1 μm and about 10 mm, and may comprise a uniform size or a distribution of sizes of granules 20 within one or more batches of granules inserted into feeder 19.

In some embodiments, EA 77 is configured to move granules 20 along column 34 toward a nozzle 27 located at the edge of column 34. EA 77 comprises one or more screw extruders 32, which are configured to be rotated about the Z-axis using an electric motor 21, which is controlled by processor 66. In the present example, EA 77 comprises screw extruders 32a and 32b, which are integrated within the inner volume of column 34, and are configured to move granules 20 along the Z-axis within the column, toward substrate 44. In other embodiments, EA 77 may comprise a single screw extruder.

In some embodiments, EA 77 comprises a first heating unit 16, which is configured to heat a section 15 of column 34, and a second heating unit 18, which is configured to heat a section 17 of column 34. Both heating units 16 and 18 are based on electrical resistivity of heating elements (or using any other suitable technique), and are controlled by processor 66 for setting the temperature of sections 15 and 17, respectively. In the present example, heating unit 16 is configured to increase the temperature in section 15 to about 150° C., which is higher than the glass-transition temperature of granules 20 and increases the viscosity and pliability of granules 20. Moreover, heating unit 18 is configured to increase the temperature in section 17 to about 180° C., which is higher than the melting temperature of granules 20. As shown in FIGS. 2A and 2B, granules 20 are pliable in section 15 and are melted to produce a molten polymer, which may or may not have particles (e.g., of cotton) immersed within the molten polymer formed by melting the granules.

In some embodiments, EA 77 comprises cooling ribs 26, which are configured to dissipate the heat produced in sections 15 and 17, so as to retain the structure of granules 20 as inserted into feeder 19.

In some embodiments, EA 77 is configured to output the molten granules, via nozzle 27, onto the surface of substrate 44. Note that while applying the molten granules, processor 66 controls motion assembly 13 to move EA 77 along the Y-axis, and to vibrate substrate in directions 12, as described in FIG. 1 above. In such embodiments, EA 77 is configured to produce the line of filament 22 onto substrate 44.

Reference is now made to an inset 28. In other embodiments, instead of nozzle 27, EA 77 comprises a nozzle assembly 29 having a plurality of nozzles 27, each of which is configured to apply the molten granules to the surface of substrate 44, so as to produce multiple lines of respective filaments at the same time (and thereby, to increase the production rate of the fabric).

Reference is now made back to the general view of FIG. 2A. In some embodiments, EA 77 comprises a shaft 24, which is configured to transfer the rotation produced by motor 21 into screw extruders 32a and 32b, so as to move granules 20. EA 77 further comprises a spring 25 and a motor 23, which is configured to compress spring by moving a bracket 7 toward motor 21.

Reference is now made to FIG. 2B. In some embodiments, when spring 25 is in the compressed position, and processor 66 controls motor 23 to release bracket 7, the spring is released and pushes the molten granules toward substrate 44. In such embodiments, the kinetic energy of spring 25 is transferred to the molten granules within column 34 for increasing the flow rate of the molten granules toward substrate 44. Because the movement speed of EA 77 is constant, the increased flow rate of the molten granules results in the formation of puddle 33 on the surface of substrate 44, which is described in FIG. 1 above. Note that in practice shaft 24 is typically not being shortened, and motor 21 is not moved toward column 34 as shown in FIG. 2B, but the drawing in FIG. 2B is used for the sake of conceptual clarity, so as to show one implementation related to the formation of puddle 33. Moreover, motor 23 and cooling ribs 26 are intentionally omitted from FIG. 2B, for the sake of conceptual clarity.

In other embodiments, instead of or in addition to spring 25 and moor 23, EA 77 may comprise any other suitable mechanism for increasing the flow rate of the molten granules during a predefined time interval, so as to produce puddle 33 on the surface of substrate 44.

In some embodiments, EA 77 comprises an air curtain 37, which is configured to improve the shaping and the attachment of filament 22 and puddle 33 at their intended position on the surface of substrate 44. Note that air curtain 37 is shown only in FIG. 2B for the sake of simplicity and presentation clarity, and is typically surrounding at least part of and typically all the sides of column 34.

In other embodiments, EA 77 may comprise one or more additional feeders (not shown), which are configured to feed one or more respective colors into column 34, so as to control the color of filaments 22 and puddles 33.

In some embodiments, at least some of granules 20 may have one or more colors, so as to produce filaments 22 in any suitable color. Additionally, or alternatively, one or more colors may be: (i) added into column 34, e.g., using a liquid feeder (not shown), and/or (ii) being applied to one or more of filaments 22 and/or bundles 33 after being formed on substrate 44.

This particular configuration of EA 77 is simplified and shown by way of example, in order to illustrate certain problems that are addressed by embodiments of the present invention and to demonstrate the application of these embodiments in enhancing the performance of such a system. Embodiments of the present invention, however, are by no means limited to this specific sort of example assembly and system, and the principles described herein may similarly be applied to other sorts of liquid dispensers and other sorts of systems for producing clothes and fabrics.

### Producing Layers of Fabrics and Clothes

FIGS. 3, 4, 5, and 6 are schematic, pictorial illustrations of arrangement of bundles 55 in layers 40 of respective fabrics, in accordance with embodiments of the present invention. In some embodiments, each item of clothing or fabric comprises one or more layers, and the bundles of FIGS. 3-6 are produced using the techniques described in FIGS. 1, 2A and 2B above.

In some embodiments, motion assembly 13 is configured to rotate substrate 44, about a rotation axis, clockwise and counterclockwise in direction 14 (shown in FIG. 1 above), so as to produce a layer 40 of the respective fabric or item of clothing.

Reference is now made to FIG. 3 showing a layer 40a of a fabric.

In some embodiments, layer 40a comprises four arrays of bundles 55a, 55b, 55c and 55d arranged in a crisscross configuration of a mesh, and produced using a processing sequence described herein. In an example of the process sequence, processor 66 controls EA 77 and motion assembly 13 to: (i) produce the array of bundles 55a, (ii) rotate substrate 44 at an angle of about 90 degrees clockwise, (iii) produce the array of bundles 55b, (iv) rotate substrate 44 at an angle of about 90 degrees counterclockwise, (v) produce the array of bundles 55c, (vi) rotate substrate 44 at an angle of about 90 degrees clockwise, and (vii) produce the array of bundles 55d. Note that the process sequence described above enable intertwining of the bundles of layer 40a. Moreover, processor 66 controls motion assembly 13 to pause the vibration while rotating substrate 44 clockwise or counterclockwise.

In the example of FIG. 3, bundles 55a and 55c are arranged on substrate 44 orthogonal to bundles 55b and 55d, and also orthogonal to the edge of layer 40a. The orthogonality between the bundles is obtained by the rotation angle of substrate 44, and the orthogonality between the bundles and the edge of layer 40a is obtained in the setup of system 11.

Reference is now made to FIG. 5 showing the structure of a layer 40c. In some embodiments, bundles 55a and 55c are arranged on substrate 44 orthogonal to bundles 55b and 55d, but are not orthogonal to the edge of layer 40c. For example, an angle 42a between bundles 55c and 55d is about 90 degrees, and an angle 42b between bundle 55c is smaller than 90 degrees.

Reference is now made to FIG. 6 showing the structure of a layer 40d. In some embodiments, bundles 55a and 55c not orthogonal to bundles 55b and 55d, and are also not orthogonal to the edge of layer 40d. For example, an angle 42c between bundles 55a and 55b is smaller than 90 degrees, and an angle 42d between bundle 55a and the edge of layer 40d is also smaller than 90 degrees.

Reference is now made to FIG. 4 showing the structure of a layer 40b. In some embodiments, layer 40b comprises one or more reinforcement points (RPs) 88 produced by welding between bundles 55, which are intertwined with one another, for example, by locally heating bundle 55c disposed over a bundle 55b. In other embodiments, RP 88 may be produced using a soldering process.

In the example of FIGS. 40b and 40d, all RPs 88 are similar, but their density and arrangement affects the mechanical properties, e.g., the flexibility and tensile strength, of the respective layers. Note that RPs 88 are arranged uniformly in FIGS. 4 and 6.

In other embodiments, the distribution of RPs 88 may not be uniform along the layer. For example, a first section of the layer may have RPs 88, and another section of the layer may not have any RPs 88, or may have a lower density of RPs 88 compared to that of the first section.

Reference is now made back to FIG. 3. In some embodiments, layer 40a may comprise different types of RPs 88. For example, RPs 88a at a first section, and RPs 88b, which are different from RPs 88a, at a second section. The difference between RPs 88a and 88b may be obtained by the amount and type of soldering material, and/or in the soldering or welding process applied at each type of RP 88. The difference between RPs 88a and 88b may result, for example, in different tensile strength of the respective sections.

In other embodiments, the arrangement of bundles 55 and the specification of the item of clothing may not require the use of any RP 88 in one or more layers of the respective item of clothing. For example, layer 40c of FIG. 5 may not have any RP 88. Moreover, a given item of clothing may have multiple layers, which may be like one another, or different from one another. For example, the given item of clothing may have an inner layer 40c (that does not have RPs 88 and is therefore smoother) and an outer layer 40a, which is more rigid.

In some embodiments, processor 66 is configured to determine the number of layers 40 in each item of clothing, and the structure of each layer (e.g., the number of filaments 22 and puddles 33 in each bundle 55, and the density and arrangement of bundles 55) within the item of clothing.

In some embodiments, the density of bundles 55, the crisscross arrangement thereof, the type of and density of RPs 88 and the number and arrangement of layers, may result in different physical properties of the finished item of clothing. For example, the tensile strength, the ductility (e.g., level of elongation), the transparency to light and/or air, the reflectivity, the weight, the breathability, the foldability, and the durability, may all be affected by the structure of the one or more layers of the fabric of the item of clothing. Moreover, different sections of each layer and/or fabric of the item of clothing may have different structures that may result in different physical properties.

In other embodiments, instead of a mesh arranged in a predefined crisscross configuration, processor 66 is configured to control EA 77 and motion assembly 13 to dispose one or more bundles 55 in an irregular pattern arranged in a suitable two-dimensional (2D) or three-dimensional (3D) configuration. In such embodiments, processor 66 is configured to control EA 77 to apply RPs 88 at selected locations of the pattern so as to control one or more physical properties of the layer and/or fabric being produced by system 11. Additionally, or alternatively, processor 66 is configured to control a laser assembly to direct a laser beam to predefined locations of the pattern for welding two or more of the bundles 55 together.

In alternative embodiments, processor 66 is configured to control EA 77 and motion assembly 13 to dispose one or more bundles 55 using multiple layers 40 arranged in a 3D configuration, each layer 40 may have any suitable shape other than crisscrossed lines. For example, a first section of a first layer 40y may have one or more bundles 55 arranged in a set of concentric or non-concentric circles, and a second section of a second layer 40z, may be produced over the first section of first layer 40y, and may have any suitable arrangement of bundles 55 that may be welded to one or more sections of the bundles 55 arranged in the set of concentric or non-concentric circles. Such non-crisscross structures may define, in one or more respective sections of the respective item of clothing, physical properties that may not be obtained using the crisscross configurations described in FIGS. 3-6 above.

The structure of layers 40a-40d, and layers 40y-40z is provided by way of example, and the principles described herein may similarly be applied to other sorts of layers and one or more sections of other layers of a fabric or an item of clothing produced by system 11 using the techniques described above.

FIG. 7 is a block diagram that schematically illustrates a machine-learning based module 50, which is configured to automatically determine a mechanical structure of a fabric based on physical properties of the fabric, in accordance with an embodiment of the present invention.

In some embodiments, module 50 may be implemented in software in processor 66, or in hardware using any suitable devices. Module 50 comprises a machine learning (ML) engine 54, which is trained (as will be described herein) to receive an input 52 of attributes of physical properties of a given fabric or item of clothing, and to output a recipe 56 for system 11, which comprises a mechanical structure of filaments 22, puddles 33, bundles 55 and layers 40, and the process flow for producing them.

In some embodiments, ML engine 54 may be implemented using any suitable type of an artificial neural network. Artificial neural networks (ANNs) are statistical models directly inspired by, and partially modeled on biological neural networks. They are capable of modeling and processing nonlinear relationships between inputs and outputs in parallel. In the present example, ML engine may comprise a convolutional neural network (CNN) or any other suitable type of one or more neural networks. The CNN comprises (i) one or more dropout layers, (ii) multi-layered convolution filters implemented in suitable tensors of convolution layers, and (iii) one or more fully connected layers, also referred to herein as dense layers.

In some embodiments, processor 66 is configured to receive information about an existing fabric of interest. The information may comprise physical properties such as but not limited to the tensile strength, ductility (e.g., level of elongation), transparency to light and/or air, reflectivity, smoothness, weight, breathability, color(s), foldability, and the durability, of the fabric or item of clothing.

Additionally, or alternatively, processor 66 is configured to receive information related to the corresponding mechanical structure of the fabric in question. For example, the information may comprise surface properties, thickness of the bundles, pattern of colors and bundles, and arrangement of the bundles (e.g., as described in FIGS. 3-6 above), space between (i) adjacent rows, and (ii) adjacent columns of the bundles, orientation of the bundles, number of layers, number of filaments and puddles in each type of bundle, and any other suitable information that is related to the structure of the fabric in question.

In some embodiments, processor 66 is configured to store in memory 75 a database comprising the physical properties and the corresponding structure of each layer and each fabric or item of clothing. Processor 66 may use this database for training ML engine 54, e.g., using supervised learning or reinforced learning techniques.

In some embodiments, multiple types of training sets may be used for training the CNN of ML engine 54. For example, (i) each fabric and item of clothing may be classified based on any suitable classification, such as the physical properties described above, (ii) a camera may be used in suitable magnifications for acquiring images of available fabrics and clothes of each class, (iii) for each fabric or item of clothing, an input set of (a) one or more images, and (b) a label indicative of the physical properties, is inserted into the CNN as input, (iv) the input image is manipulated by the dropout layers, convolution layers, and dense layers, and (v) the CNN outputs a structure of each layer of the fabric or item of clothing intended to be produced. In the present example, the output may comprise at least one parameter selected from a list of parameters consisting of: (i) the size (e.g., thickness defined by number of filaments 22) of each bundle 55, (ii) a first distance between adjacent bundles 55 along a first axis of the fabric or item of clothing, (iii) a second distance between adjacent bundles 55 along a second axis of the fabric or item of clothing, (iv) an angle 42 between each pair of bundles 55 arranged along the first axis and the second axis, (v) estimated locations of reinforcement points (RPs) 88 in a grid of the bundles 55 that are arranged along the first axis and the second axis, and any other suitable parameter.

In some embodiments, processor 66 is configured to use supervised learning techniques for training the CNN by feeding back the corresponding parameters, so that after a certain number of training-sets the model of the CNN converges for at least one class of fabrics and clothes. Additionally, or alternatively, a reinforcement learning may be used for training the CNN. For example, after receiving the output parameters from the CNN, a user or processor 66, may provide the CNN with (i) an OK or not OK feedback to the entire set of output parameters, or to each output parameter, or (ii) an estimated accuracy of the output (e.g., in percentage). Each output parameter may have a weight, and a score, and processor 66 is configured to calculate the estimated accuracy based on the weight and score of each output parameter. The CNN is configured to converge after a suitable number of training sets.

In some embodiments, processor 66 is configured to hold one or more thresholds indicative of the accuracy criterion of the CNN, and once the accuracy criterion is met on one or more verification sets, the CNN has a trained model, and the training of ML engine 54 has been concluded.

In some embodiments, processor 66 is configured to produce a user interface (UI) for a designer of a fabric and/or an item of clothing. The UI may comprise input fields of the attributes of the physical properties of the designed fabric or item of clothing, and processor 66 is configured to output the structure of each layer and/or fabric or item of clothing using the trained ML engine 54 or any other suitable artificial intelligence (AI) technique.

In some embodiments, processor 66 is configured to output a model of the fabric or item of clothing, and the corresponding structure of each layer thereof. In some embodiments, after a verification and/or optimization input from the user, processor 66 is configured to produce one or more recipes that may be used by system 11 for producing the desired fabric or item of clothing. At least one of the recipes may be produced during an inference stage of the trained ML engine 54.

FIG. 8 is a schematic, pictorial illustration of a shirt 61 produced using system 11, in accordance with an embodiment of the present invention.

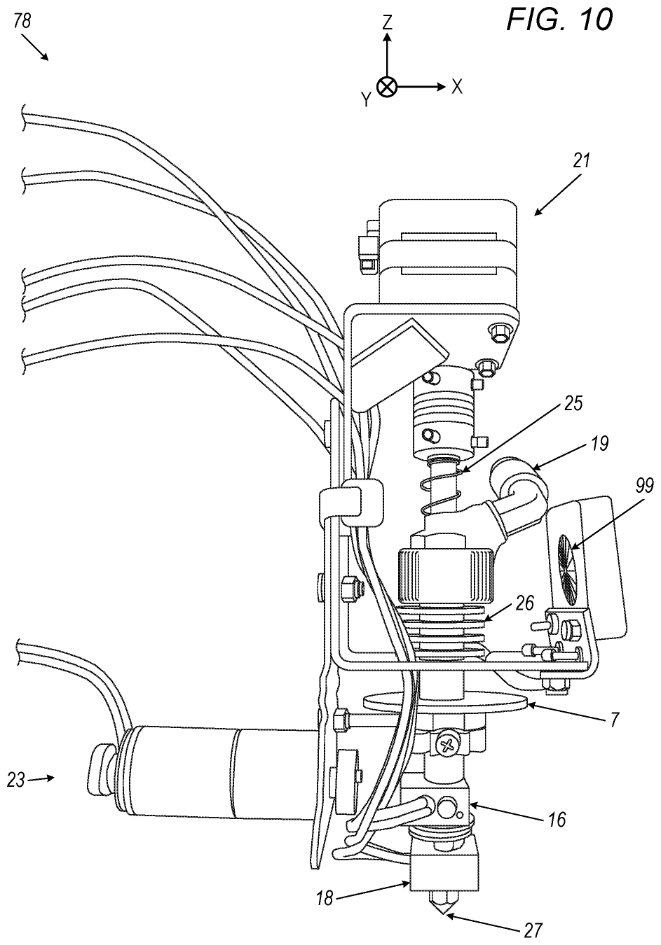

Typically, shirt 61, and other types of clothes, have a front side and a backside. In some embodiments, processor 66 is configured to control EA 77 and motion assembly 13 to produce the front side and backside of shirt 61 using the techniques described in FIGS. 1-7 above and in FIG. 9 below.

In some embodiments, each side of shirt 61 may be produced as a single polygon (e.g., a rectangle), and subsequently, redundant sections 64 of the polygon are removed (e.g., by cutting them off) to produce the designed shape of shirt 61. As described in FIG. 2A above, sections 64 may be recycled to produce granules 20 that may be used to produce additional clothes, such as shirt 61.

In the present example, processor 66 is configured to control EA 77 and motion assembly 13 to produce the designed shape directly, so that no redundant fabric (e.g., the fabric of sections 64) is being removed. This technique reduces waste and/or recycling resources, and therefore, improves the environmental friendliness of the production process.

In some embodiments, after producing the front side and backside of shirt 61, a sheet 62 (also referred to herein as a delamination layer) is placed between the front and back sides of shirt 61, so as to prevent undesired bonding between the front side and the back side.

In some embodiments, sheet 62 comprises any suitable substance, such as acrylonitrile butadiene styrene (ABS) polymer with polypropylene configured to prevent the bonding between the front side and the backside (also referred to herein as delamination between the front side and the back side of shirt 61). In other embodiments, any suitable technique, other than the delamination layer, may be used to prevent the bonding.

In some embodiments, sheet 62 has the designed shape of shirt 61, but the size of sheet 62 is slightly smaller than that of shirt 61, so as to align edges 67 of the front and back sides of shirt 61 and having them placed in direct contact with one another. In such embodiments, respective edges 67 of the front and back sides of shirt 61 are coupled to one another using any suitable technique. For example, a laser beam may be used for heating the respective edges 67 and bonding them to one another, a suturing machine may be used for stitching the edges together, or any other suitable technique may be used for coupling between the respective edges 67 of the front and back sides of shirt 61.

In other embodiments, a sheet 65 having a shape of a polygon and made from a suitable delamination substance, as described for sheet 62 above, may be placed between the front and back sides of shirt 61, and may be folded before coupling between the respective edges 67 of the front and back sides of shirt 61.

FIG. 9 is a flow chart that schematically illustrates a method for producing an item of clothing, in accordance with an embodiment of the present invention. In the present example, the item of clothing comprises shirt 61 of FIG. 8 above.

The method begins at a definition step 100 with processor 66 or any other suitable device, which is configured to define process parameters to obtain selected mechanical structure of each layer of shirt 61. At least one of the layers may have one or more sections, each of which having a different structure of the filaments, bundles, and other components. The components and process parameters are described in detail in FIGS. 1-8 above. More specifically, based on a list of desired physical properties, the mechanical structure of shirt 61 may be defined using machine learning (ML) techniques described in FIG. 7 above.

At a granules insertion step 102, a user of system 11 or a robot insert granules 20 into feeder 19 of extrusion assembly (EA) 77, as described in FIGS. 2A and 2B above.

At a granule moving step 104, EA 77 is configured to move granules 20 into column 34 of EA 77, and subsequently, one of more screw extruders 32 of EA 77 are rotated (e.g., by electric motor 21) about the Z-axis, so as to move granules 20 toward one or more nozzles 27, as described in FIGS. 2A and 2B above.

At a melting step 106, processor 66 controls heating units 16 and 18 to increase the temperature of granules 20 above the glass temperature (T_{g}) and above the melting temperature (Tₘ) in respective sections 15 and 17 of column 34, as described in FIG. 2A above.

At a filament production step 108, processor 66 controls EA 77 and motion assembly 13 to produce filaments 22 and puddles 33 by applying molten granules to substrate 44 while moving EA 77 relative to substrate 44, and optionally, vibrating substrate 44 in directions 12, as described in FIGS. 1, 2A and 2B above.

At a bundle and layer production step 110, processor 66 controls EA 77 and motion assembly 13 to produce bundles 55 and layers 40 using a selected crisscross configuration by: (i) vibrating substrate 44 for intertwining groups of filaments 22 together, (ii) grouping multiple filaments 22 by puddles 33, (iii) rotating substrate 44 about the Z-axis relative to EA 77 for producing the desired crisscross configuration, and optionally, (iv) welding or soldering one or more RPs 88 between selected bundles 33 crossing one another at predefined locations within the respective layer 40, as described in detail in FIGS. 1-6 above. Note that steps 108 and 110 may be carried out uniformly across shirt 61, or differently in different sections of the item of clothing or fabric, as described, for example, in FIG. 3 above.

In some embodiments, step 110 concludes the production of a first layer 40 of shirt 61.

At a decision step 112, processor 66 decides whether shirt 61 has additional layers 40. In case an additional layer 40 must be produced, the method loops back to step 100. In case no additional layers 40 have to be produced, the method proceeds to a side coupling step 114 that concludes the method. In step 114, the front side and back side of shirt 61 are produced, and edges 67 of the front side and back side of shirt 61 are coupled to one another for producing shirt 61, as described in detail in FIG. 8 below.

The method of FIG. 9 is simplified for the sake of conceptual clarity, and the production process of shirt 61 may comprise additional steps, such as but not limited to (i) the insertion of colors (e.g., into column 34) for applying a desired color to shirt 61 or to each section thereof, and (ii) the production of granules 20, e.g., by recycling old clothes and fabrics.

FIG. 10 is an image of an EA 78, in accordance with another embodiment of the present invention. EA 78 may replace, for example, EA 77 of FIGS. 1, 2A and 2B above.

In some embodiments, EA 78 comprises motor 23 and bracket 7 positioned between cooling ribs 26 and heating unit 16. In such embodiments, processor 66 is configured to control motor 23 to move bracket 7 upward along the Z-axis (e.g., toward motor 21), so as to apply, via nozzle 27, an increased amount of the molten granules, and thereby, produce puddle 33 on the surface of substrate 44.

In some embodiments, EA 78 comprises a fan 99, which is configured to apply wind to cooling ribs 26 for dissipating the heat produced by heating units 16 and 18, as described in FIG. 2A above, so as to retain the structure of granules 20 (shown in FIGS. 2A and 2B above) as inserted into feeder 19.

Although the embodiments described herein mainly address production of clothes and fabrics, the methods and systems described herein can also be used in other applications.

It will thus be appreciated that the embodiments described above are cited by way of example, and that the present invention is not limited to what has been particularly shown and described hereinabove. Rather, the scope of the present invention includes both combinations and sub-combinations of the various features described hereinabove, as well as variations and modifications thereof which would occur to persons skilled in the art upon reading the foregoing description and which are not disclosed in the prior art. Documents incorporated by reference in the present patent application are to be considered an integral part of the application except that to the extent any terms are defined in these incorporated documents in a manner that conflicts with the definitions made explicitly or implicitly in the present specification, only the definitions in the present specification should be considered.

1. A system, comprising:
an extrusion assembly (EA), which is configured to melt granules of one or more substances and to output the molten granules onto a substrate;
a motion assembly, which is configured to move the EA relative to the substrate along a first axis, and to vibrate the substrate along a second axis, different from the first axis, while the EA outputs the molten granules so as to produce a line of a filament on the substrate; and
a processor, which is configured to control the EA and the motion assembly to dispose the filament on a predefined region of the substrate.

2. The system according to claim 1, wherein the EA is configured to produce, along the line, one or more puddles of the molten granules.

3. The system according to claim 2, wherein the EA is configured to produce a section of the line by pulling a portion of the molten granules from the puddle and disposing the pulled portion on the substrate along the first axis.

4. The system according to claim 1, wherein the processor is configured to determine the predefined region by controlling: (i) a first movement profile for moving the EA along the first axis, and a second moving profile for vibrating the substrate in the second axis.

5. The system according to claim 1, wherein the processor is configured to control the motion assembly to move the EA in an opposite direction along the first axis, so as to dispose an additional filament on an additional predefined region of the substrate.

6. The system according to claim 5, wherein at least a portion of the predefined region overlaps at least a portion of the additional predefined region.

7. The system according to claim 6, wherein the processor is configured to control the motion assembly and the EA to produce a plurality of the filaments and the additional filaments, and to produce a first array of one or more bundles by coupling, in each of the bundles, between two or more of the filaments and the additional filaments.

8. The system according to claim 7, wherein the processor is configured to control the motion assembly and the EA to produce at least one of the bundles by intertwining between one or more of the filaments and one or more of the additional filaments.

9. The system according to claim 7, wherein the processor is configured to control the motion assembly and the EA to produce at least one of the bundles by coupling, two or more of the filaments and the additional filaments, to a puddle of the molten granules.

10. The system according to claim 7, wherein the motion assembly is configured to rotate the substrate about a rotation axis, and wherein the processor is configured to control: (i) the motion assembly to rotate the substrate at a predefined rotation angle, and (ii) the motion assembly and the EA to produce, on the substrate, a second array of one or more of the bundles.

11. The system according to claim 10, wherein the processor is configured to control the motion assembly and the EA to produce a layer comprising at least two of the bundles of the first and second arrays intertwined with one another.

12. The system according to claim 11, wherein the processor is configured to control the motion assembly and the EA to produce the intertwined bundles in a crisscross configuration.

13. The system according to claim 12, wherein the processor is configured to control the motion assembly and the EA to produce the intertwined bundles at first and second orientations, respectively, wherein the first and second orientations define a given angle between the intertwined bundles.

14. The system according to claim 11, wherein the processor is configured to control the motion assembly and the EA to produce one or more reinforcement points (RPs) between one or more pairs of the intertwined bundles.

15. The system according to claim 14, wherein the processor is configured to control the motion assembly and the EA to produce at least one of the RPs by welding at least one of the pairs to one another.

16-32. (canceled)

33. The system according to claim 1, wherein the EA comprises an air curtain, which is configured to perform one or both of: (i) shaping the line of the filament produced on the substrate, and (ii) improving an attachment of the line of the filament to the substrate.

34-35. (canceled)

36. The system according to claim 1, and comprising a machine learning (ML) engine, which is configured receive an input comprising one or more attributes of one or more physical properties of a fabric, and to output a mechanical structure of the fabric.

37-42. (canceled)

43. A method, comprising:
melting, in an extrusion assembly (EA), granules of one or more substances and outputting the molten granules onto a substrate; and
moving the EA relative to the substrate along a first axis, and vibrating the substrate along a second axis, different from the first axis, while the EA outputs the molten granules so as to produce a line of a filament on the substrate.

44. The method according to claim 43, and comprising producing, along the line, one or more puddles of the molten granules.

45. The method according to claim 44, and comprising producing a section of the line by pulling a portion of the molten granules from the puddle and disposing the pulled portion on the substrate along the first axis.
